(19) United States
(12) Patent Application Publication
(10) Pub. No.: US 2012/0160015 A1
(43) Pub. Date: Jun. 28, 2012

(54) METHODS FOR PREDICTING FOULING TENDENCIES OF HYDROCARBON CONTAINING FEEDSTOCKS

(75) Inventors: Cesar Ovalles, Walnut Creek, CA (US); Estrella Rogel, Orinda, CA (US); Michael E. Moir, San Rafael, CA (US)

(73) Assignee: Chevron U.S.A. Inc., San Ramon, CA (US)

(21) Appl. No.: 13/046,556

(22) Filed: Mar. 11, 2011

Related U.S. Application Data
(60) Provisional application No. 61/426,392, filed on Dec. 22, 2010.
(60) Provisional application No. 61/312,765, filed on Mar. 11, 2010.

(51) Int. Cl. G01N 30/02

(52) U.S. Cl. 73/61.52

(57) ABSTRACT

Disclosed is a method involving the steps of (a) precipitating an amount of asphaltenes from a liquid sample of a first hydrocarbon-containing feedstock having solvated asphaltenes therein with one or more first solvents in a column; (b) determining one or more solubility characteristics of the precipitated asphaltenes; (c) analyzing the one or more solubility characteristics of the precipitated asphaltenes; and (d) correlating a measurement of feedstock fouling tendencies for the first hydrocarbon-containing feedstock sample with a mathematical parameter derived from the results of analyzing the one or more solubility characteristics of the precipitated asphaltenes.

### RELATED APPLICATIONS

The present application claims priority to U.S. Ser. No. 61/312,765 filed Mar. 11, 2010 and U.S. Ser. No. 61/428,392 filed Dec. 30, 2010 the contents of which are hereby incorporated by reference in their entireties.

### TECHNICAL FIELD

The present invention relates to methods for predicting fouling tendencies of hydrocarbon containing feedstocks used with hydroprocessing equipment.

### BACKGROUND OF THE INVENTION

One of the problems encountered in crude oil production and refining is asphaltene precipitation. Generally, unwanted asphaltene precipitation is a concern to the petroleum industry due to, for example, plugging of an oil well or pipeline as well as stopping or decreasing oil production. Also, in downstream applications, asphaltenes are believed to be the source of coke during thermal upgrading processes thereby reducing and limiting yield of residue conversion. In catalytic upgrading processes, asphaltenes can contribute to catalyst poisoning by coke and metal deposition thereby limiting the activity of the catalyst.

Asphaltenes can also cause fouling in, for example, heat exchangers and other equipment in a refinery. Fouling in heat transfer equipment used for streams of petroleum origin can result from a number of mechanisms including chemical reactions, corrosion and the deposit of materials made insoluble by the temperature difference between the fluid and heat exchange wall. The presence of insoluble contaminants may exacerbate the problem: blends of a low-sulfur, low asphaltene (LSLA) crude oil and a high-sulfur, high asphaltene (HSHA) crude, for example, may be subject to a significant increase in fouling in the presence of iron oxide (rust) particulates. Subsequent exposure of the precipitated asphaltenes over time to high temperatures then causes formation of coke as a result of thermal degradation.

Equipment fouling is costly to petroleum refineries and other plants in terms of lost efficiencies, lost throughput, and additional energy consumption. With the increased cost of energy, heat exchanger fouling can have a significant impact on process profitability. Higher operating costs also accrue from the cleaning required to remove fouling. While many types of refinery equipment are affected by fouling, cost estimates have shown that the majority of profit losses occur due to processing of thermally unstable crude oil blends and fractions and subsequently fouling.

Fouling is generally characterized as the accumulation of unwanted materials on the surfaces of processing equipment. In petroleum processing, fouling is the accumulation of unwanted hydrocarbon-based deposits on, for example, heat exchanger surfaces. It has been recognized as a nearly universal problem in design and operation of refining and petrochemical processing systems, and affects the operation of equipment in two ways. First, the fouling layer has a low thermal conductivity. This increases the resistance to heat transfer and reduces the effectiveness of the heat exchangers. Second, as deposition occurs, the cross-sectional area of tubes in the heat exchanger is reduced, which causes an increase in pressure drop across the apparatus and creates inefficient pressure and flow in the heat exchanger.

One of the more common causes of rapid fouling, in particular, is the formation of coke that occurs when crude oil asphaltenes are overexposed to heater tube surface temperatures. The liquids on the other side of the exchanger are much hotter than the whole crude oils and result in relatively high surface or skin temperatures. Certain asphaltenes can precipitate from the oil and adhere to these hot surfaces. Another common cause of rapid fouling is attributed to the presence of salts and particulates. Salts/particulates can precipitate from the crude oils and adhere to the hot surfaces of the heat exchanger. Inorganic contaminants play both an initiating and promoting role in the fouling of whole crude oils and blends. Iron oxide, iron sulfide, calcium carbonate, silica, sodium and calcium chlorides have all been found to be attached directly to the surface of fouled heater rods and throughout the coke deposit.

The cleaning process, whether chemical or mechanical, in petroleum refineries and petrochemical plants often causes costly shutdowns. A majority of refineries practice off-line cleaning of heat exchanger tube bundles based on scheduled time or usage or on actual monitored fouling conditions. Reduction in the extent of fouling would lead to increased run lengths, improved performance and energy efficiency while also reducing the need for costly fouling mitigation options.

In addition, oil refining gives rise to dark, heavy, high-boiling oil fractions and their mixtures, of which bitumen and heavy fuel oil are made, among other things. The use and storability of these oil raffinates are impaired by the poor solubility or precipitation of asphaltenes in the oil. Thus, susceptibility of the asphaltene components to precipitate determines the stability or storability of the oil, and this depends both on the oil production process used and on the raw materials.

Falker discloses a method (Falker, T. J., U.S. Pat. No. 5,753,802 (1998)) for analyzing the fouling tendency of FCC (Fluid Catalytic Cracking) bottoms by heating the bottoms for two hours in an autoclave at a variety of temperatures in the range of 360-380° C. Then the amounts of gravimetric asphaltenes recovered from the bottoms are determined by conventional precipitation techniques. By comparing the amount of asphaltenes generated for a sample obtained at different autoclave temperatures, the determination of the relative fouling propensity for each sample can be obtained. The fouling tendency increases with the asphaltenes content in the product and decreases in the presence of a chemical antifoulant.

From the above, it is clear the amount and the composition of asphaltenes and other heavy organic molecules present in feeds and products play an important role for solid and deposit formation. Fouling of crude oils and their products is a very complex phenomenon, and remains a challenge to the petroleum industry.

It would be desirable to provide improved methods for determining fouling tendencies of a hydrocarbon-containing feedstocks in equipment that can be carried out in a simple, cost efficient and repeatable manner. Subsequently, strategies can be designed for mitigation and control of fouling knowing the tendencies of the hydrocarbon-containing feedstock to foul equipment.

### SUMMARY OF THE INVENTION

In accordance with one embodiment of the present invention, there is provided a method comprising the steps of:

(a) precipitating an amount of asphaltenes from a liquid sample of a first hydrocarbon-containing feedstock having solvated asphaltenes therein with one or more first solvents in a column;

(b) determining one or more solubility characteristics of the precipitated asphaltenes;

(c) analyzing the one or more solubility characteristics of the precipitated asphaltenes; and

(d) correlating a measurement of at least one fouling tendency for the first hydrocarbon-containing petroleum sample with a mathematical parameter derived from the results of analyzing the one or more solubility characteristics of the precipitated asphaltenes.

In accordance with a second embodiment of the present invention, there is provided a method comprising the steps of:

(a) precipitating an amount of asphaltenes from a liquid sample of a first hydrocarbon-containing sample having solvated asphaltenes therein with one or more first solvents in a column;

(b) determining one or more solubility characteristics of the precipitated asphaltenes;

(c) analyzing the one or more solubility characteristics of the precipitated asphaltenes;

(d) correlating a measurement of at least on fouling tendency for the first hydrocarbon-containing hydrocarbon sample with a mathematical parameter derived from the results of analyzing the one or more solubility characteristics of the precipitated asphaltenes; and

(e) selecting a different sample of the same first hydrocarbon-containing feedstock and comparing the different sample with the results of the first hydrocarbon-containing feedstock sample.

In accordance with a third embodiment of the present invention, a method is disclosed comprising the steps of:

(a) subjecting a hydrocarbon containing sample to a selected pressure above atmospheric pressure and to a selected temperature; maintaining the sample at the selected pressure and temperature for a selected time;

(b) cooling the sample and reducing the pressure;

(c) precipitating asphaltenes from the sample having solvated asphaltenes therein with one or more first solvents in a column;

(d) determining one or more solubility characteristics of the precipitated asphaltenes;

(e) analyzing the one or more solubility characteristics of the precipitated asphaltenes; and

(f) correlating a measurement of at least one fouling tendency for the first hydrocarbon-containing sample with a mathematical parameter derived from the results of analyzing the one or more solubility characteristics of the precipitated asphaltenes.

In a fourth embodiment, there is provided a method for determining asphaltene stability in a hydrocarbon-containing feedstock having solvated asphaltenes therein, the method comprising the steps of:

(a) precipitating an amount of the asphaltenes from a liquid sample of the hydrocarbon-containing material with an alkane mobile phase solvent in a column;

(b) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent;

(c) monitoring the concentration of eluted fractions from the column;

(d) creating a solubility profile of the dissolved asphaltenes in the hydrocarbon-containing material; and

(e) correlating a measurement of at least one fouling tendency for the first hydrocarbon-containing sample with a mathematical parameter derived from the solubility profile.

The methods advantageously predict the fouling tendencies of a hydrocarbon-containing samples in a simple, cost efficient and repeatable manner.

### BRIEF DESCRIPTION OF THE DRAWINGS

FIG. 1 shows two graphs of asphaltene solubility fractions for samples derived from two reference feedstocks showing the response versus time using an Evaporative Light Scanning Detector;

FIG. 2 is a graph showing a correlation between fouling factor R_{f} for a variety of hydrocarbon samples containing asphaltenes versus their ratios of high to low polarity asphaltene fractions as determined by an Asphaltene Solubility Fraction Method;

FIG. 3 is a schematic drawing of a heat exchanger used in tests to determine fouling factors R_{f} of samples taken over time and as graphed in FIG. 2;

FIG. 4 is a graph showing correlations between incremental high polar Asphaltenes and temperatures for a pair of feedstock samples autoclaved at a plurality of temperatures prior to using the Asphaltene Solubility Fraction Method to determine high polar asphaltene fractions; and

FIG. 5 shows a pair of solubility profiles for two samples of feedstocks, one having a relatively high fouling tendency and one having a relatively low fouling tendency.

### DETAILED DESCRIPTION OF THE PREFERRED EMBODIMENTS

In this disclosure, methods are described for the prediction of the fouling tendencies of petroleum derived samples from feedstocks on hydroprocessing components. In one embodiment, the fraction of a sample that is insoluble in paraffins (e.g. n-heptane) is called asphaltenes and a soluble fraction is referred to as maltenes. In an exemplary embodiment, the asphaltenes are separated into four different fractions according to their solubility in four selected solvents, i.e., mixtures of dichloromethane in heptane and methanol in dichloromethane (see below for more details). The relative concentration of these fractions in the feedstock is correlated with its fouling propensity on a hydroprocessing component or conduit. Using this correlation, fouling tendencies of other samples can be predicted knowing the solubility characteristics of the other samples.

In one exemplary embodiment, a method involves (a) precipitating an amount of asphaltenes from a liquid sample of a first hydrocarbon-containing feedstock having solvated asphaltenes therein with one or more first solvents in a column; (b) determining one or more solubility characteristics of the precipitated asphaltenes; (c) analyzing the one or more solubility characteristics of the precipitated asphaltenes; and (d) correlating a measurement of fouling tendency for the first hydrocarbon-containing feedstock sample with a mathematical parameter derived from the results of analyzing the one or more solubility characteristics of the precipitated asphaltenes.

Generally, the source of the hydrocarbon-containing feedstock may be any source wherefrom a hydrocarbon crude may be obtained, produced, or the like. By way of example and not limitation, the source may be one or more producing wells in fluid communication with a subterranean oil reservoir. The producing well(s) may be under thermal recovery conditions, or the producing well(s) may be in a heavy oil field where the hydrocarbon crude or oil is being produced from a reservoir having a strong water-drive.

In one embodiment, the hydrocarbon-containing feedstock sample includes any heavy hydrocarbons such as heavy crude oil, heavy hydrocarbons extracted from tar sands, commonly called tar sand bitumen, such as Athabasca tar sand bitumen obtained from Canada, heavy petroleum crude oils such as Venezuelan Orinoco heavy oil belt crudes, Boscan heavy oil, Hamaca crude oil, heavy hydrocarbon fractions obtained from crude petroleum oils, particularly heavy vacuum gas oils, vacuum residuum as well as petroleum tar, tar sands and coal tar. Other non-limiting examples of heavy hydrocarbon feedstocks which can be used are oil shale, shale, coal liquefaction products and the like.

In another embodiment, the hydrocarbon-containing feedstock sample includes any solid hydrocarbon-containing deposit such as asphaltene solids from, e.g., refinery production preparation or an oil facility.

In another embodiment, the hydrocarbon-containing feedstock sample includes any processed sample such as heavy cycle gas oil (HCGO), LC Fining products, fluid catalytic cracking (FCC) products and the like.

In one embodiment, a liquid sample of a hydrocarbon-containing feedstock having solvated asphaltenes therein is provided. As one skilled in the art will readily appreciate, it may be necessary to add a solvent to the hydrocarbon-containing feedstock in order for the sample to be sufficiently fluid to be passed through a column. Useful solvents include solvents in which the hydrocarbon-containing feedstock sample is soluble or which is capable of allowing the hydrocarbon-containing feedstock sample to be sufficiently fluid to be passed through the column. Representative examples of such solvents include one or more chlorinated hydrocarbon solvents, one or more aromatic hydrocarbon solvents, one or more ether solvents, one or more alcohol solvents and the like and mixtures thereof. Suitable chlorinated hydrocarbon solvents include, but are not limited to, dichloromethane, 1,2-dichloroethane, chloroform, carbon tetrachloride and the like and mixtures thereof. Suitable aromatic hydrocarbon solvents include, but are not limited to, benzene, toluene, xylene and the like and mixtures thereof. Suitable ether solvents include tetrahydrofuran, diethylether, dioxane and the like and mixtures of thereof. Suitable alcohol solvents include low molecular weight aliphatic alcohols such as methanol, ethanol, isopropanol and the like and mixtures thereof.

In one embodiment, the sample solution can be prepared from about 10 to about 50 wt. % solution of the hydrocarbon-containing feedstock sample in the solvent(s).

Initially, at least a portion of the sample solution is injected into a column. Generally, the column will have an inlet and an outlet and can be any type of column which is hollow and permits the flow of an aqueous-type material through the interior of the column. The column can be any size and cross sectional shape, e.g., the column can be cylindrical, square, rectangular, triangular, or any other geometrical shape as long as it is hollow and permits the passing of aqueous-type material. In one embodiment, the column is cylindrical. Furthermore, the column can be of any suitable length and any inner diameter or inner cross-sectional area. In one embodiment, the column can have a diameter of from about 0.25 inches (0.64 cm) to about 1 inch (2.54 cm) and a length of from about 50 mm to about 500 mm. One skilled in the art could envisage that the column can generally be any inert filtration device for use with the methods of the present invention.

Any suitable material may be selected for use as the column. For example, the column can be formed of a relatively inert or chemically unreactive material such as glass, stainless steel, polyethylene, polytetrafluoroethylene (PTFE), polyaryletheretherketone, (PEEK), silicon carbide or mixtures of thereof, for example, a PEEK-lined stainless steel column.

The column may be vertical or horizontal or arranged in any suitable way, provided that it can be loaded with the sample solution and that the appropriate solvent(s) can be passed through it. As will be understood by those of ordinary skill in the art, a pump may also be used to increase the flow rate through the column.

In another embodiment, an inert packing material is included within the column. The amount of the inert packing material should not exceed an amount that will prevent the passing of any liquid containing material through the column. The packed column advantageously allows for the use of a relatively small volume of sample solution and solvent(s). Suitable inert packing material includes any material that is inert to asphaltene irreversible adsorption. Examples of such materials include fluorinated polymers such as, for example, polyvinylidene fluoride (PVDF), fluorinated ethylene propylene (FEP), polytetrafluoroethylene (PTFE), silicon carbide, polydivinylbenzene (PDVB) and the like and mixtures thereof.

Once the sample solution has been passed into the column, one or more first solvents are then passed through the column. Useful one or more first solvents are typically alkane mobile phase solvent(s) and can be determined by one skilled in the art. In one embodiment, the alkane mobile phase solvent is n-heptane. By way of example and not limitation, other alkane mobile phase solvents such as, for example, n-pentane or n-hexane may be used.

The one or more first solvents should be passed into the column for a time period sufficient to elute the alkane soluble fraction, commonly known as maltenes or petrolenes, and induce precipitation of the alkane insoluble fraction, i.e., the precipitated asphaltenes, from the hydrocarbon-containing feedstock sample. Generally, once the alkane mobile phase solvent (i.e., one or more first solvents) enters the column, the alkane mobile phase solvent dilutes and displaces the solvent in the sample solution, thereby allowing the asphaltenes to substantially precipitate therefrom. The alkane soluble fraction then elutes from the column.

One or more solubility characteristics of the precipitated asphaltenes is then determined once substantially all of the alkane soluble fraction has eluted. The one or more solubility characteristics of the precipitated asphaltenes to be determined include, by way of example, solubility parameters, miscibility numbers, kauri-butanol numbers, dipole moments, relative permitivities, polarity indexes, refractive indexes and specific types of intermolecular interaction in liquid media such as acid and base numbers. Various ways to determine the one or more solubility characteristics of the precipitated asphaltenes are within the purview of one skilled in the art.

For example, in one embodiment, the step of determining one or more solubility characteristics of the precipitated asphaltenes involves (1) dissolving at least part of the amount of the precipitated asphaltenes in one or more second solvents having a solubility parameter at least 0.7 MPa^{0.5} higher than the one or more first solvents; and (2) dissolving a second amount of the precipitated asphaltenes in one or more third solvents having a solubility parameter higher than the one or more second solvents, wherein the solubility parameter of the one or more third solvents is at least about 21 MPa^{0.5} but no greater than about 30 MPa^{0.5}. A solubility parameter as described herein is determined by the Hansen's methodology described in Barton, A. F. M. Handbook of Solubility Parameters and Other Cohesion Parameters; CRC Press Inc.: Boca Raton, Fla., p. 95 (1983).

Suitable one or more second solvents having a solubility parameter at least 0.7 MPa^{0.5} higher than the one or more first solvents can be determined by one skilled in the art. Useful solvents include, but are not limited to, one or more alkane solvents, one or more chlorinated hydrocarbon solvents, one or more aromatic solvents, one or more ether solvents, one or more alcohol solvents and the like and mixtures thereof. Representative examples of such solvents can be any of those disclosed above. It is also contemplated that blends of such solvents can be used. In one embodiment, a blend can contain from about 0.5 wt. % to about 99.5 wt. % chlorinated solvent and from about 99.5 wt. % to about 0.5 wt. % alkane solvent. In another embodiment, a blend can contain from about 10 wt. % to about 25 wt. % chlorinated solvent and from about 90 wt. % to about 75 wt. % alkane solvent.

Suitable one or more third solvents having a solubility parameter higher than the one or more second solvents, wherein the solubility parameter of the one or more third solvents is at least about 21 MPa^{0.5} but no greater than about 30 MPa^{0.5}, can be determined by one skilled in the art. Generally, the one or more third solvents will dissolve any remaining precipitated asphaltenes in the column. Useful solvents include, but are not limited to, one or more alcohol solvents, one or more chlorinated hydrocarbon solvents, one or more aromatic solvents, one or more ether second solvents and the like and mixtures thereof. Representative examples of such solvents can be any of those disclosed above. It is also contemplated that blends of such solvents can be used. In one embodiment, a blend can contain from about 0.5 wt. % to about 99.5 wt. % chlorinated solvent and from about 99.5 wt. % to about 0.5 wt. % alcohol solvent. In another embodiment, a blend can contain from about 80 wt. % to about 95 wt. % chlorinated solvent and from about 20 wt. % to about 5 wt. % alcohol solvent.

If desired, one or more additional solvents or solvent blends can be added to dissolve at least part of the amount of the precipitated asphaltenes after the addition of the one or more second solvents and before the addition of the one or more third solvents. In general, the one or more additional solvents or solvent blends will have a solubility parameter greater than the previously added one or more solvents or solvent blends and less than the solubility parameter of the one or more third solvents. For example, one or more fourth solvents having a solubility parameter between the solubility parameter of the one or more second solvents and the solubility parameter of the one or more third solvents can be added to dissolve at least part of the amount of the precipitated asphaltenes. In another embodiment, one or more fifth solvents having a solubility parameter between the solubility parameter of the one or more fourth solvents and the solubility parameter of the one or more third solvents can be added to dissolve at least part of the amount of the precipitated asphaltenes. In yet another embodiment, one or more sixth solvents having a solubility parameter between the solubility parameter of the one or more fifth solvents and the solubility parameter of the one or more third solvents can be added to dissolve at least part of the amount of the precipitated asphaltenes.

Suitable additional solvents include, but are not limited to, one or more alkane solvents, one or more chlorinated hydrocarbon solvents, one or more alcohol solvents, one or more aromatic solvents and the like and mixtures thereof. Representative examples of such solvents can be any of those disclosed above.

The asphaltene concentration in the eluted fractions from the column is continuously monitored using, for example, a liquid chromatography detector that generates a signal proportional to the amount of each eluted fraction and is recorded in a manner well known in the art. There are a number of commercially available liquid chromatography detectors that can be used including, e.g., refractive index detectors, mass spectrometry, liquid chromatography/mass spectrometry, NMR spectroscopy, Raman spectroscopy, infrared spectroscopy, fluorescence spectroscopy, UV-Vis spectroscopy, diode array detector, charged aerosol, evaporative light scattering detectors (ELSD) and the like; all of which can be used in the methods described herein. Other online detectors are known to those skilled in the art. Quantification can then be performed using methods known in the art, e.g., using commercially-available computer programs.

In one preferred embodiment, an evaporative light scattering detector is used as a liquid chromatography detector to monitor each eluting sample's concentration to determine the solubility characteristics of the precipitated asphaltenes. The operating principle of an evaporative light scattering detector is as follows: the compounds to be analyzed are transported by a mobile phase or a more volatile carrier liquid which is then nebullized and evaporated at a relatively low temperature (about 30° C. to about 150° C.) so that residual micro-particles alone remain—ideally the compounds to be analyzed—which can be detected by light scattering. In this manner, it is possible to analyze directly effluents that originate from the column under the condition of selecting a mobile phase which is volatile enough to be directly used as a carrier liquid for the evaporative light scattering detector. For example, in the case of the asphaltenes, the result is a single peak for each eluted solvent fraction that represents the solubility characteristics of the asphaltenes.

Once the one or more solubility characteristics have been analyzed for a given hydrocarbon-containing feedstock sample, a mathematical parameter derived from the one or more solubility characteristics is correlated with one or more measurements of fouling tendencies of the hydrocarbon-containing sample. For example, a mathematical parameter can be derived by calculating a percentage of each peak area for the first amount or the second amount of dissolved asphaltenes relative to the total peak areas, wherein the peak areas are derived from the signals generated from the detector. Other mathematical parameters derived from the one or more solubility characteristics are within the purview of one skilled in the art and illustrated in the examples herein.

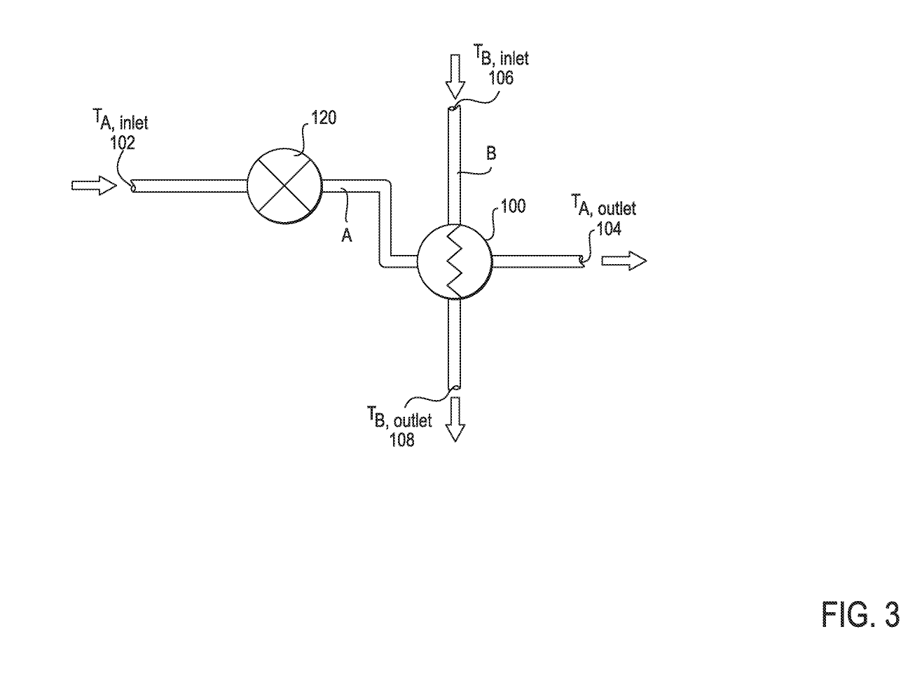

For the purposes of this application, “fouling tendency” shall refer to the tendency of asphaltenes accumulate on a surface, such as that of a heat exchanger. Depending on the asphaltene content of a particular feedstock, the fouling tendency may occur at slow rate or at a faster rate. One example of how the fouling tendency may be calculated is described below with respect to Example 2, using a fouling factor R_{f}, as a measure of fouling. Another example of fouling tendency is shown in FIG. 3, wherein samples of two different feedstock are each heated at a plurality of different temperatures for an extended period of time, cooled, with samples then evaluated for high polar content. The fouling tendency is a function of the incremental increase in parts per million of high polar asphaltenes contained within the samples. Generally, the higher the temperature, the greater the production of high polar asphaltenes.

Falkler, U.S. Pat. No. 5,753,802, entitled Methods for Testing the Fouling Tendency of FCC Slurries, describes methods which may be used to determine fouling tendencies. The content of this patent is hereby incorporated by reference in its entirety. These methods may also be used to arrive at fouling tendencies which can be correlated against a mathematical parameter derived from the results of analyzing one or more solubility characteristics, obtained such as by using the Asphaltene Solubility Fraction Method.

Fouling factors and their determinations are described in a number of patents such as U.S. Pat. Nos. 7,799,206 and 7,682,460, and patent applications WO2004/099349 and WO03/103863. Those skilled in the art will appreciate there are numerous other ways to determine a fouling factor or fouling tendency associated with fouling rates of asphaltenes and other foulants accumulating such as on hydroprocessing equipment. These various ways may be used so that correlations may be made with the one or more mathematical parameters related to solubilities can be done to predict fouling tendencies for other feedstocks.

In one embodiment a measure of fouling loss of a component, also qualitatively known as Fouling Factor R_{f}, is related to the lowering of heat transfer rates resulting from corrosion, deposit or sediment formation, or roughness of the surface of tube walls of heat exchangers or similar type of units. The fouling factor (R_{f}) is defined in terms of the heat flux Q/A (in which Q=heat transfer rate in BTU/hr and A is the area in which the heat exchange takes place (in ft²) and the temperature difference across the fouling unit ΔT_{f} (in ° F.). Further details on calculations are given with respect to Example 2.

Using this parameter R_{f} or any other parameter indicative of fouling tendency, allows the measurement the fouling rate of the component to be determined and its value monitored as a function of time. As the fouling factor increases, the propensity of a component to degrade or fail also increases so the unit should be monitored for potential cleaning. As many different hydrocarbon containing samples are passed through the component, the fouling factor changes so the operator has to closely monitor this parameter to optimize the operating conditions and avoid financial losses.

With knowledge of fouling tendencies for different hydrocarbon containing samples, optimized blends of feedstocks can be made. For example, a problematic sample (relatively high fouling tendency) and a non-problematic sample (relatively low fouling tendency) can be appropriately mixed so that the fouling rate of the unit is reduced. Alternatively, pressure and/or temperature can be controlled to reduce fouling rate by reducing the asphaltene generation during operation of a component. Additionally, an estimate can be made of the optimum amount of an anti-foulant additive to be mixed with a problematic hydrocarbon containing stream.

In a fourth embodiment, there is provided a method for determining asphaltene stability in a hydrocarbon-containing feedstock having solvated asphaltenes therein, the method comprising the steps of:

(a) precipitating an amount of the asphaltenes from a liquid sample of the hydrocarbon-containing material with an alkane mobile phase solvent in a column;

(b) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent;

(c) monitoring the concentration of eluted fractions from the column;

(d) creating a solubility profile of the dissolved asphaltenes in the hydrocarbon-containing material; and

(e) correlating a measurement of at least one fouling tendency for the first hydrocarbon-containing sample with a mathematical parameter derived from the solubility profile.

The tendency to foul of a feedstock, by way of example and not limitation, may be for one or more crude hydrocarbon refinery components including a heat exchanger, a furnace, a crude preheater, a coker preheater, a FCC slurry bottom, a debutanizer exchange, a debutanizer tower, a feed/effluent exchanger, a furnace air preheater, a flare compressor component, a steam cracker, a steam reformer, a distillation column, a fractionation column, a scrubber, a liquid-jacketed tank, a pipestill, a coker, a storage tank and a visbreaker.

The following non-limiting examples are illustrative of the present invention.

### Example 1

### Asphaltene Solubility Fraction Method

Solutions for four reference hydrocarbon containing samples were prepared by dissolving 0.1000 g of the feedstocks in 10 mL of methylene chloride. The solutions were injected into a separate stainless steel column packed with poly(tetrafluoroethylene) (PTFE) using a heptane mobile phase (Solubility Parameter of 15.3 MPa^{0.5}) at a flow rate of 4 mL/min. Maltenes (heptane solubles) were eluted from the column as a first peak around 2 minutes after the injection. The mobile phase was then switched in successive steps to solvents of increasing solubility parameters: (1) 10 minutes after the addition of the heptane phase, a blend of 15% dichloromethane/85% n-heptane (Solubility Parameter of 16.05 MPa^{0.5}) was added to the column; (2) 20 minutes after the addition of the blend of 15% dichloromethane/85% n-heptane, a blend of 30% dichloromethane/70% n-heptane (Solubility Parameter of 18.8 MPa^{0.5}) was added to the column; (3) 30 minutes after the addition of the blend of 30% dichloromethane/70% n-heptane, 100% dichloromethane (Solubility Parameter of 20.3 MPa^{0.5}) was added to the column; and (4) 40 minutes after the addition of 100% dichloromethane, a blend of 10% methanol/90% dichloromethane (Solubility Parameter of 21.23 MPa^{0.5}) was added to the column. In this manner, four different asphaltenes solubility fractions were separated with a total analysis time of approximately 50 to 55 minutes.

The eluted fractions were quantified using an Evaporative Light Scanning Detector (ELSD) operating at the following conditions: drift tube temperature 75° C.; volumetric flow of the solvents was 4.0 mL/min. and 3.5 L/min. of nitrogen as the nebullizing gas. The light scattered by the non-volatile particles was collected and is a measure of the concentration of the solute in the column effluent. For the case of asphaltenes, the measurement of the light scattered, also known as response, represents the solubility characteristics of the asphaltenes present in the sample.

The eluted fractions were also quantified using a Diode Array Detector (DAD) operating at 495 nm. In this case, the absorbance of each asphaltene fraction is directly proportional to its concentration present in the sample.

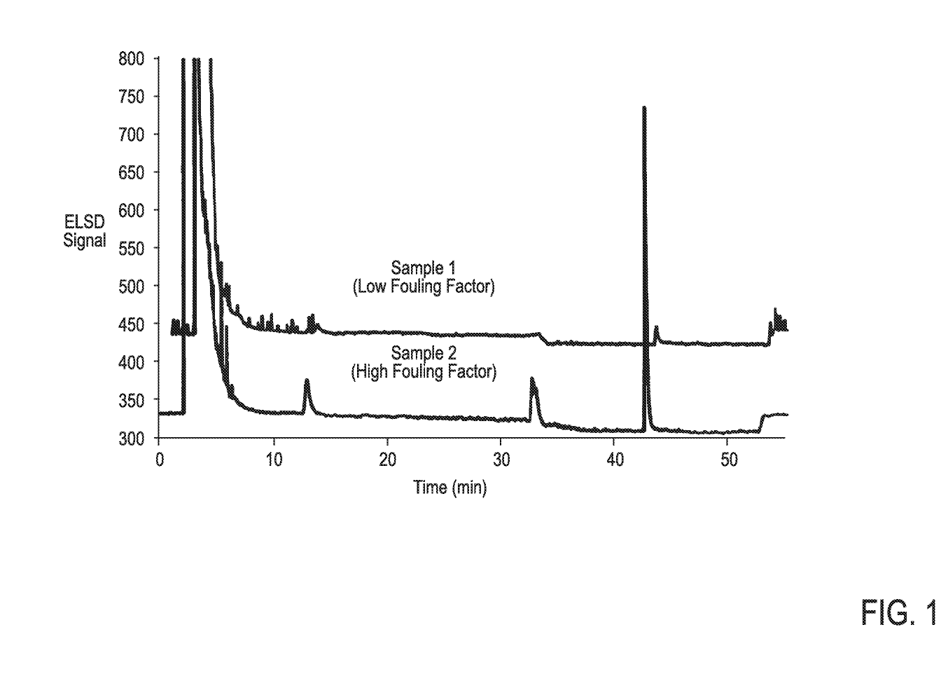

FIG. 1 shows the resulting solubility characteristics of the asphaltene solubility fraction distributions for two petroleum-containing samples as response versus time using the ELSD. The presence of five distinct features is represented by separated peaks. In FIG. 1, the first peak corresponds to the eluted maltenes (heptane solubles) and the last four peaks correspond to each of the eluted asphaltenes from the four different solvent additions. From left to right, the asphaltenes are separated in increasing solubility parameters, i.e., the first and second peaks are considered “low polarity” asphaltenes and the last two peaks are considered “high polarity” asphaltenes. The ELSD allows for calculating a percentage of peak area for each of the dissolved asphaltenes.

### Example 2

Prepare a solution of 10 to 50% wt solution of a hydrocarbon containing sample in a suitable solvent such as dichloromethane (CH₂Cl₂) or Toluene.

A small portion (40 μL) of the solution is injected into a stainless steel column packed with poly(tetrafluoroethylene) (PTFE) using a heptane mobile phase. Maltenes (heptane solubles) elute from the column as the first peak. The mobile phase is then switched sequentially to 15% dichloromethane in heptane, 30% dichloromethane in heptane, 100% dichloromethane and 10% methanol in dichloromethane. The percentages of the asphaltene soluble fractions are calculated using the following correlation between the mass and the area under the peak to determine the mass of each fraction and then dividing each mass by the total mass of the crude oil sample.

Calculate the areas under the peaks using conventional integration procedures. Determine the ratio of high to low polarity of asphaltenes. The high polarity asphaltenes are dissolved in 100% dichloromethane and 10% methanol in dichloromethane and the low polarity asphaltenes are dissolved in 10% dichloromethane in heptane and 30% dichloromethane in heptane.

As can be seen in FIG. 1, sample 1 has the lowest concentration of high polarity asphaltenes and has a low fouling rate in comparison with sample 2. This example shows how the Asphaltene Solubility Fraction Method can be used to predict the fouling tendency of a petroleum-containing hydrocarbon.

As seen in a schematic view in FIG. 3, an asphaltene containing fluid and water flows through a heat exchanger 100 in complementary tubes A and B, respectively. A supply of water is provided to a water inlet 106 of tube B to remove heat from the asphaltene containing fluid flowing through tube A. The heat from the water is passed from a water outlet 108 to subsequently generate steam. Similarly, the asphaltene containing fluid flows into an inlet 102 of the tube A, through tube A, with heat be passed to the water and then out an outlet 104 of tube A at a reduced temperature. A flow meter 120 measure the flow (lbs/hour) of the asphaltene containing fluid passing through heat exchanger 100.

The fouling factor R_{f} is related to the tendency of the heat exchanger to foul due the passage of the asphaltene containing fluid under particular operating conditions, i.e., temperatures of the asphaltene containing fluid and water. As the fouling factor R_{f} increases, indicating more accumulation of fouling material on the inside heat exchange tube A, the ability of the heat exchanger to exchange heat diminishes. Knowing how fast the fouling factor R_{f} increases, the tendency of a feedstock to cause fouling can be estimated. Eventually, the heat exchanger must be cleaned or replaced to return to an economical rate of heat exchange.

The fouling factor (R_{f}) for the heat exchanger due to the asphaltene containing fluid passing through the heat exchanger may be calculated as follows:

Fouling Factor(R_{f})=(1/U_{actual})−(1/U_{design}) (1)

U_{actual,design}=Q_{actual,design}/(A×LMDT)
where Q=m/t×Cp(Tᵢₙₗₑt−Tₒᵤₜₗₑₜ)=heat transfer rate
where m=mass of asphaltene containing fluid through heat exchanger (lbs mass);
   t=time that mass of asphaltene containing fluid flows through heat exchanger fouling the heat exchanger (hour);
   Cp=heat capacity of the asphaltene containing fluid that flows through heat exchanger (BTU/lb);
   Tᵢₙₗₑₜ=average temperature of asphaltene containing fluid into of heat exchanger (Fahrenheit);
   Tₒᵤₜₗₑₜ=average temperature of asphaltene containing fluid out of heat exchanger);

$$\begin{matrix}LMDT = Log meant temperature difference ; \\ = ( Δ {T}_{A} - Δ {T}_{B} ) / ( ln ( Δ {T}_{A} / Δ {T}_{B} ) )\end{matrix}$$

where ΔT_{A}=temperature change across heat exchange tube A;
ΔT_{B}=temperature change across heat exchange tube B;

Log mean temperature difference (LMTD) describes the temperature driving force for heat transfer in flow systems. In this particular instance, the system is a heat exchanger; LMDT is a logarithmic average of the temperature difference between the hot and cold streams at each end of the heat exchanger. The greater LMDT is, the greater the amount of heat that is transferred. LMTD assume that there is constant flow rate and that the flow has constant fluid thermal properties.

Fouling Factor (R_{f})) was calculated for a heat exchanger utilizing Equation (1) above over the course of approximately one year at occasion dates. Asphaltene content and polarity were determined for samples taken. Occasionally the heat exchanger was cleaned producing lower fouling factor. Knowing how fast the fouling factor changes with time, is indicative of the fouling tendency of a feedstock on equipment.

TABLE 1
FCC Slurry Bottoms and Fouling Factor in Heat Exchanger

| | | | | | | High | |
|---|---|---|---|---|---|---|---|
| | | Content | % Low | % High | | Polar. | |
| | | Asphaltenes | Polarity | Polarity | Ratio | Asphaltenes | Fouling |
| Day | API | (ppm) | Asphaltenes | Asphaltenes | HP/LP | (ppm) | Factor |
| 1 | 1.5 | 7107 | 18.8% | 81.2% | 4.32 | 5771 | 0.024 |
| 49 | | 3944 | 14.2% | 85.8% | 6.04 | 3384 | |
| 81 | 0.3 | 137 | 42.6% | 57.4% | 1.35 | 79 | 0.001 |
| 105 | 0.9 | 5816 | 26.9% | 73.1% | 2.72 | 4254 | 0.005 |
| 119 | 1.2 | 7350 | 35.0% | 65.0% | 1.86 | 4778 | 0.006 |
| 161 | | 3394 | 37.8% | 62.2% | 1.65 | 2111 | 0.001 |
| 180 | | 186 | 40.4% | 59.6% | 1.48 | 111 | 0.001 |
| 194 | 0.1 | 5570 | 43.6% | 56.4% | 1.29 | 3141 | 0.002 |
| 211 | 0.5 | 3886 | 30.4% | 69.6% | 2.29 | 2705 | 0.001 |
| 239 | −1.0 | 4355 | 31.3% | 68.7% | 2.19 | 2992 | 0.009 |
| 254 | | 11796 | 24.5% | 75.5% | 3.08 | 8906 | 0.010 |
| 268 | | 7577 | 16.2% | 83.8% | 5.17 | 6350 | 0.015 |
| 310 | | 8967 | 30.5% | 69.5% | 2.28 | 6232 | 0.002 |
| 324 | −0.1 | 1056 | 26.0% | 74.0% | 2.85 | 781 | 0.003 |
| 328 | | 8966 | 23.0% | 77.0% | 3.35 | 6904 | 0.005 |
| 344 | −1.7 | 5034 | 29.5% | 70.5% | 2.39 | 3549 | 0.008 |

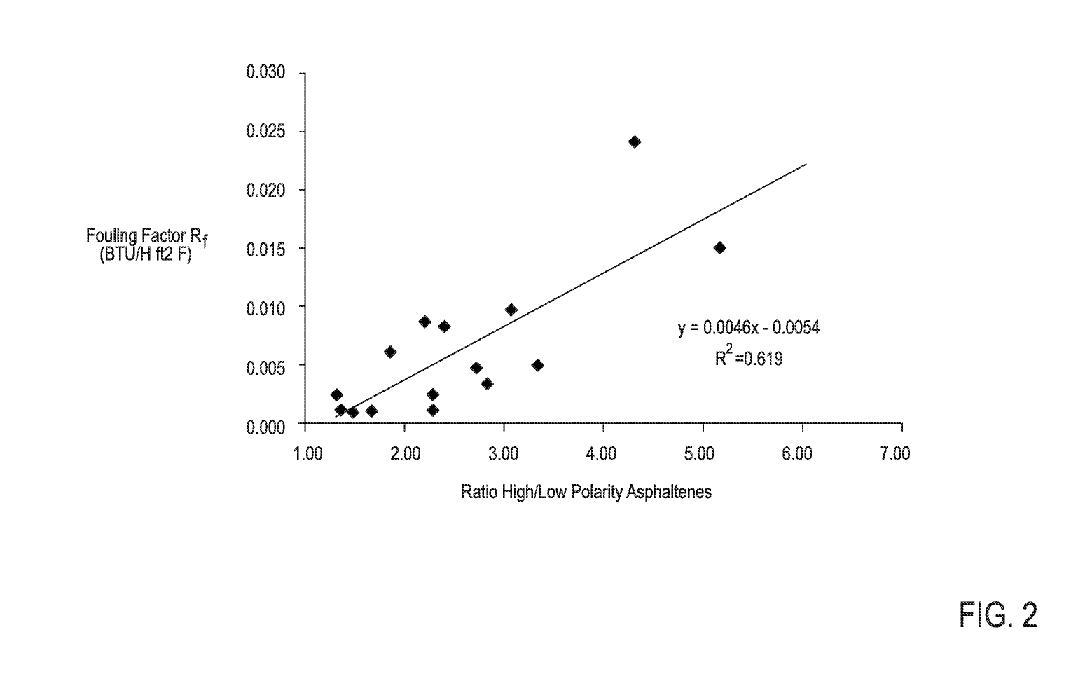

The fouling factor vs. ratio of high to low polarity of asphaltenes are plotted. As can be seen in FIG. 2, the fouling factor is proportional to the ratio of high to low polarity of asphaltenes present in the petroleum sample with a correlation factor of 0.619. The line and equation for the line represent the correlation in FIG. 2. Knowing how the fouling factor changes over time can be related to the solubility characteristics of a feedstock. This example shows how the Asphaltene Solubility Fraction Method of Example 1 can be used to predict the fouling tendency of a petroleum-containing hydrocarbon with respect to hydrocarbon processing equipment.

### Example 3

An autoclave reactor was loaded with 70 g of the petroleum sample and purged with nitrogen at least six times.

The reactor was pressurized to 29 psi of nitrogen and heated at 5° C./min up to the desired temperature (320-360° C.). Top end temperatures included 320° C., 335° C., 345° C., and 355° C.

After four hours, the reactor was cooled to room temperature, and each sample was weighed and characterized by the Asphaltene Solubility Fraction Method.

The increase in high polarity asphaltenes (100% dichloromethane and 10% methanol in dichloromethane solubles) was plotted versus temperature.

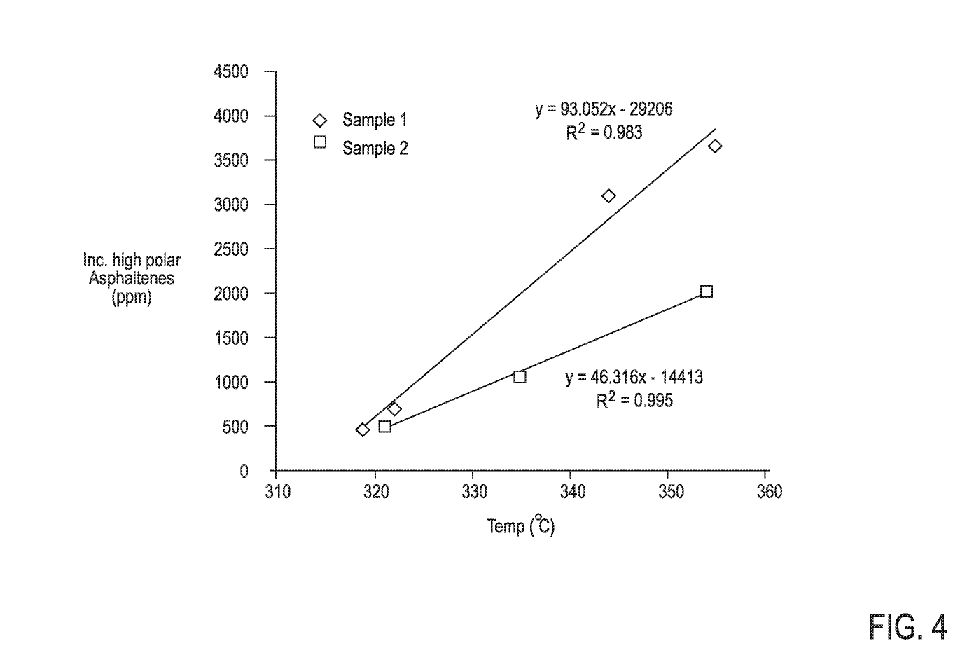

As shown in FIG. 4, the high polarity asphaltenes increase with the temperature of the reactor. The increase in this asphaltene fraction is accompanied by an increase in the fouling tendency.

### Example 4

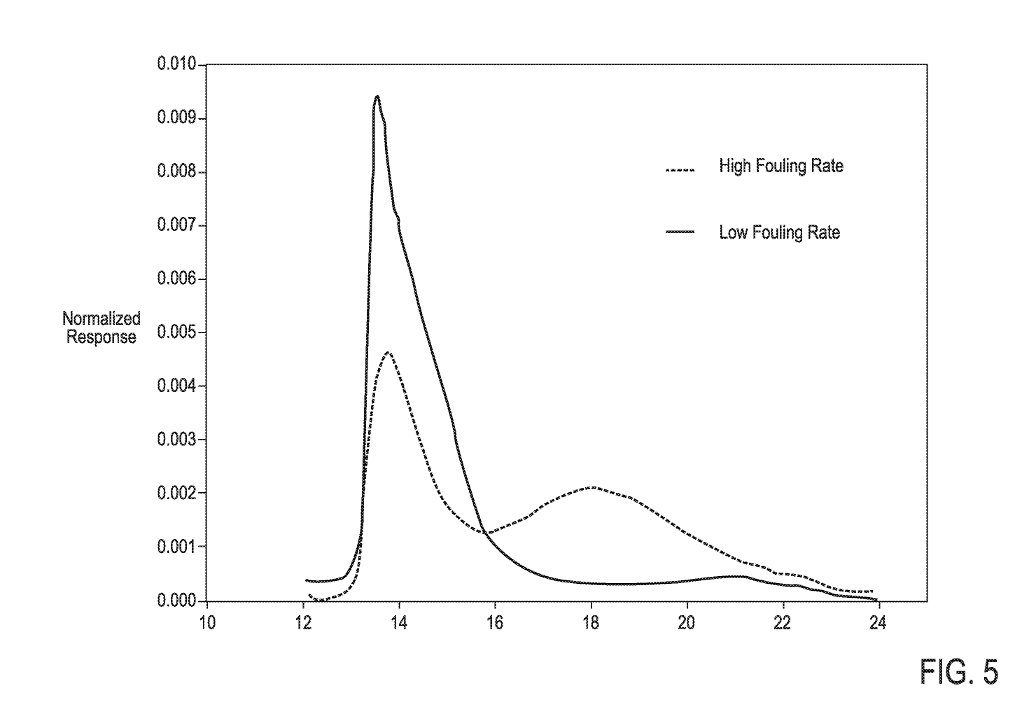

FIG. 5 shows liquid chromatography traces determined using an Asphaltene Solubility Method. As can be seen, there is a dramatic difference in the shapes of the curves for the samples studied. The high fouling rate curve shows a main peak around 14 minutes (lower polarity) and its asphaltenes solubility profile ends around 17 minutes. On the other hand, the sample corresponding to the period with fouling issues have a peak at 14 minutes and 18 minutes and a much wider solubility profile which ends around 24 minutes. In general, wider asphaltene solubility profiles are found in unstable samples. The lack of intermediate material around 16 minutes makes the two extreme asphaltene fractions (lower and higher polarity) insoluble in each other and with high tendency to precipitate. More details on the Asphaltene Solubility Method can be found in U.S. patent application Ser. No. 12/833,814 filed Jul. 9, 2010 which is hereby incorporated by reference in its entirety, also, U.S. patent application Ser. No. 12/833,802 filed on Jul. 9, 2010 is hereby incorporated by reference in its entirety.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A method comprising the steps of:
(a) precipitating an amount of asphaltenes from a liquid sample of a first hydrocarbon-containing feedstock having solvated asphaltenes therein with one or more first solvents in a column;
(b) determining one or more solubility characteristics of the precipitated asphaltenes;
(c) analyzing the one or more solubility characteristics of the precipitated asphaltenes; and
(d) correlating a measurement of feedstock fouling tendency for the first hydrocarbon-containing feedstock sample with a mathematical parameter derived from the results of analyzing the one or more solubility characteristics of the precipitated asphaltenes.

2. The method of claim 1, wherein step (b) comprises
(i) dissolving at least part of the amount of the precipitated asphaltenes in one or more second solvents having a solubility parameter at least about 0.7 MPa^{0.5} higher than the one or more first solvents;
(ii) dissolving a second amount of the precipitated asphaltenes in one or more third solvents having a solubility parameter higher than the one or more second solvents, wherein the solubility parameter of the one or more third solvents is at least about 21 MPa^{0.5} but no greater than about 30 MPa^{0.5}.

3. The method of claim 2, wherein step (c) comprises monitoring the amount of eluted fractions from the column with a liquid chromatography detector which generates a signal proportional to the amount of each eluted fraction.

4. The method of claim 3, comprising calculating a percentage of each peak area for the first amount and the second amount of dissolved asphaltenes from the total peak areas, wherein the peak areas are derived from the signals.

5. The method of claim 3, further comprising prior to step (ii):
dissolving at least part of the amount of the precipitated asphaltenes in one or more fourth solvents having a solubility parameter between the solubility parameter of the second solvent and the solubility parameter of the third solvent;
dissolving at least part of the amount of the precipitated asphaltenes in one or more fifth solvents having a solubility parameter between the solubility parameter of the fourth solvent and the solubility parameter of the third solvent.

6. The method of claim 5, wherein step (c) comprises monitoring the concentration of eluted fractions from the column with a liquid chromatography detector which generates a signal proportional to the amount of each eluted fraction.

7. The method of claim 6, comprising calculating a percentage of each peak area for the first amount and the second amount of dissolved asphaltenes from the total peak areas, wherein the peak areas are derived from the signals.

8. The method of claim 1, wherein step (b) comprises dissolving a first amount and a second amount of the precipitated asphaltenes by gradually and continuously changing the one or more first solvents to a final mobile phase solvent having a solubility parameter at least about 1 MPa^{0.5} higher than the one or more first solvents.

9. The method of claim 1, wherein step (b) comprises:
(i) gradually and continuously changing the one or more first solvents to a first final mobile phase solvent having a solubility parameter at least about 1 MPa^{0.5} higher than the one or more first solvents to dissolve a first amount of the precipitated asphaltenes; and
(ii) gradually and continuously changing the first final mobile phase solvent to a second final mobile phase solvent having a solubility parameter at least about 1 MPa^{0.5} higher than the first final mobile phase solvent to dissolve a second amount of the precipitated asphaltenes.

10. The method of claim 9, comprising
creating a solubility profile of the dissolved asphaltenes in the first hydrocarbon-containing feedstock sample; and
correlating the fouling factor against characteristics of the solubility profile.

11. The method of claim 1 wherein:
the fouling tendency is related to fouling factor R_{f} and R_{f} is calculated using the following formula:
Fouling Factor(R_{f})=(1/U_{actual})−(1/U_{design})
where
U_{actual,design}=Q_{actual,design}/(A×LMDT)
where Q=m/t×Cp (Tᵢₙₗₑt−Tₒᵤₜₗₑₜ)=heat transfer rate
where m=mass of asphaltene containing fluid passing through a heat exchanger (lbs mass);
t=time that mass of asphaltene containing fluid flows through heat exchanger fouling the heat exchanger (hour);
Cₚ=heat capacity of the asphaltene containing fluid that flows through heat exchanger (BTU/lb);
Tᵢₙₗₑₜ=average temperature of asphaltene containing fluid into of heat exchanger (Fahrenheit);
Tₒᵤₜₗₑₜ=average temperature of asphaltene containing fluid out of heat exchanger);
$$\begin{matrix}LMDT = Log meant temperature difference ; \\ = ( Δ {T}_{A} - Δ {T}_{B} ) / ( ln ( Δ {T}_{A} / Δ {T}_{B} ) )\end{matrix}$$
where ΔT_{A}=temperature change across heat exchange tube A;
ΔT_{B}=temperature change across heat exchange tube B.

12. The method of claim 1 wherein:
fouling tendencies are determined by heating at least two feedstocks at a plurality of temperatures for an extended period of time then cooled and samples of the feedstocks are analyzed for high polar asphaltene concentration to determine the effect heating the feedstock has on producing high polar asphaltenes.
